(19) United States
(12) Patent Application Publication
(10) Pub. No.: US 2006/0144523 A1
(43) Pub. Date: Jul. 6, 2006

(54) Device for the longitudinal application of an adhesive in a folder

(75) Inventors: Jean-Francois Robert, Crell (FR); Julien Samal, Clermont (FR); Thierry Thevenin, Margny Les Compiegne (FR)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Montataire S.A., Montataire (FR)

(21) Appl. No.: 10/562,519

(22) PCT Filed: Jun. 22, 2004
(86) PCT No.: PCT/EP04/06724

§ 371 Date: Dec. 23, 2005

(30) Foreign Application Priority Data
Jun. 26, 2003 (DE) 103 28 805.8

(51) Int. Cl. B32B 43/00; B32B 38/04; B32B 37/12; B05C 11/00

(52) U.S. Cl. 156/443; 156/459; 156/510; 156/513; 156/578; 118/37

(57) ABSTRACT

A device for the longitudinal application of an adhesive in a folder (13) of a webprocessing printing press (14) is disclosed. The folder (13) comprises a former board (1), a device for longitudinal perforation (5) having a perforating blade (16) that is adjustable in a direction transversal to the direction of travel (15), and a cross-cutter arranged downstream of each other in the direction of travel (15) of the web of printing material (12). The device for the longitudinal application of an adhesive includes an adhesive applicator arranged downstream of the former board (1) and upstream of the cross-cutter (8) as viewed in the direction of travel (15) and having an applicator head (22) that is adjustable with the perforating knife (16) in a correlated manner.

The invention relates to a device for the longitudinal application of an adhesive in a folder, the folder comprising a former board, a device for longitudinal perforation having a perforating blade that is adjustable in a direction transversal to the direction of travel of the web of printing material, and a cross-cutter succeeding each other in the direction of travel.

When folded sheets or signatures are produced out of a web of printing material or a number of webs of printing material (which will herein be referred to as a web of material in the singular for reasons of simplicity) in a folder of a web-processing printing press, certain folding configurations include longitudinal perforations of a web of material that has been longitudinally folded over a former board. The perforations occur before the sheet is severed from the web by a cross-cutter and are located in positions on a line along which a sheet that has been severed from the web of printing material in the folder will be folded (i.e. the future folding line, folding edge, or folding spine of the folded product). In the process, it is frequently desired to apply continuous or intermittent lines of an adhesive, in particular longitudinal gluing sections, along the line defined by the longitudinal perforation in order to adhesively bond, glue, fortify, or stabilize the signatures produced in the folder along a folding edge of folding spine. The adhesive may be in particular a glue, a reaction adhesive, a one-component adhesive, or a multi-component adhesive.

The document EP 1 025 993 A2 discloses a device for applying a longitudinal gluing in a folding apparatus of high-speed rotary printing presses comprising an adhesive applicator and a cross-cutter for severing sheets from the web of printing material. To prevent glue stains upon application of the glue and to dispense with the need for grooves in the rollers in the region of the gluing line, the adhesive applicator is arranged downstream of the cross-cutter as viewed in the direction of sheet travel and in particular located in the region of a belt conveyor. The application of the glue can be carried out in a pulsed and intermittent manner. However, the aforementioned document does not explain how the longitudinal application of glue on a web of printing material that has been perforated longitudinally along a line is to be carried out.

It is an object of the present invention to provide a device for applying an adhesive in a folder as precisely as possible along a longitudinal perforation of a web of printing material and for permitting a quick alignment of the line of adhesive with the longitudinal perforation.

According to the invention, this object is achieved by a device for the longitudinal application of an adhesive that has the features given in claim 1. Advantageous embodiments of the invention are indicated in the dependent claims.

A device according to the invention for the longitudinal application of an adhesive, in particular for applying a longitudinal line of an adhesive or glue, in a folder in which a former board, a device for longitudinal perforation with a perforating blade that is adjustable transversally with respect to the conveying direction, and a cross-cutter succeed each other in the conveying direction of the web of printing material, comprises an adhesive applicator which has an applicator head adjustable with the perforating blade in a correlated manner and is located downstream of the former board and upstream of the cross-cutter that preferably comprises a knife arranged on a rotating body. Preferably, the perforating blade of the device for longitudinal perforation is received on a rotating body. The applicator head may in particular comprise an applicator nozzle or an applicator roller. In other words, the device for longitudinal perforation and the adhesive applicator are arranged to correlate with each other. They can be adjusted jointly in the same direction, or their positions with respect to the web of printing material can be jointly altered.

In a preferred embodiment, the adhesive applicator in the device for the longitudinal application of an adhesive is controllable in a pulsed manner to permit an intermittent application of an adhesive, in particular glue, in particular in such a way that the application of the adhesive is pulsed in accordance with the severing of sheets from the web of printing material. The control device may be connected to the adhesive applicator and/or to the machine control.

Alternatively or additionally, the applicator head is preferably arranged in such a way that the adhesive is applied to the web of printing material downstream of the device for longitudinal perforation as viewed in the conveying direction. The folder may comprise a device for cross-perforation that is arranged upstream of the device for longitudinal perforation and of the adhesive applicator as viewed in the conveying direction.

It is particularly advantageous if the perforating blade and the adhesive applicator in the device for the longitudinal application of an adhesive are adjustable transversally to the conveying direction in a correlated manner by means of a common (mechanical or electric) drive. When the device for longitudinal perforation is to be changed, it is thus possible to align the adhesive line, in particular the longitudinal gluing line, and the longitudinal perforation with respect to each other in a quick and reliable manner. This also means that only few components, in particular only one motor, are required for carrying out the movement. The perforating blade and the adhesive applicator can be firmly coupled transversally to the conveying direction.

In addition, the applicator head may be adjustable to different distances from the web of printing material (in particularly continuously to various distances). Thus it is possible to accommodate the characteristics of different printing materials and different adhesives. The applicator head is preferably pivotable. In particular, the applicator head may be disengageable from the web of printing material far enough to permit longitudinal perforation without the longitudinal application of an adhesive, i.e. the applicator head may have an engaged position and a disengaged position.

In a further development of the device for the longitudinal application of an adhesive according to the invention, the adhesive applicator is received in a support that is adjustable beyond the side frame of the folder. When the adhesive applicator is adjusted beyond the side frame of the folder, it is particularly easy to access the adhesive applicator for maintenance and make-ready operations to be performed by a machine operator.

The invention also relates to a folder with at least one device for the longitudinal application of an adhesive as described herein. The folder may be a pinless folder. Moreover, the invention relates to a web-processing printing press comprising at least one folder as described herein. The web-processing printing press may in particular be a web-fed rotary printing press, a conventional or waterless lithographic printing press, a flexographic printing press, or a hybrid press with printing units operating in accordance with different printing processes, in particular flexographic printing and lithographic printing. A web-processing printing press may include a splicer, a plurality of printing units including at least one upper printing couple and one lower printing couple (typically 4, 6, or 8 printing units), a drier, and a folder. The web-processing printing press may be a commercial printing press or a newspaper press. Typical printing materials are paper, cardboard, paperboard, organic polymer foil, fabric, or the like.

Other advantages and advantageous embodiments and further developments of the present invention will be explained below based on the following figures and their descriptions. The figures include:

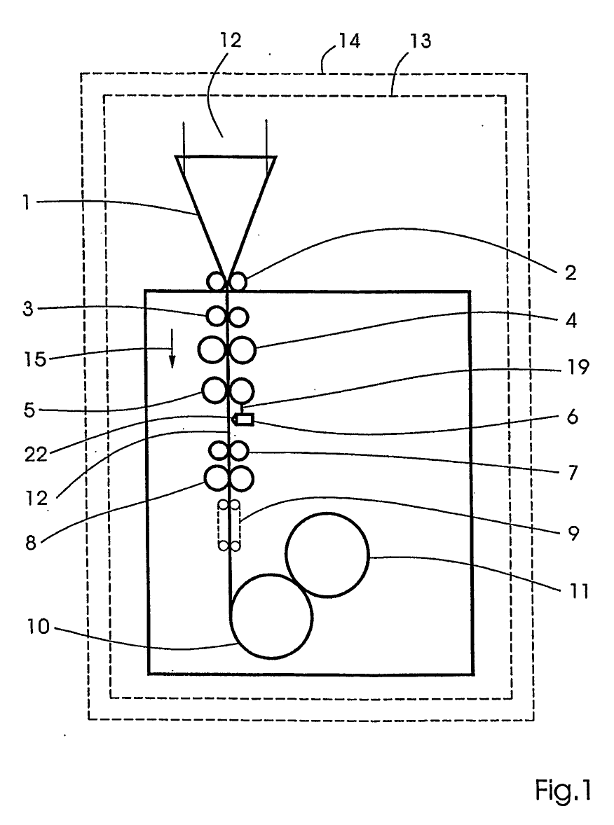

FIG. 1 showing a diagrammatic representation of an embodiment of a folder according to the invention including a device according to the invention for the longitudinal application of an adhesive, and

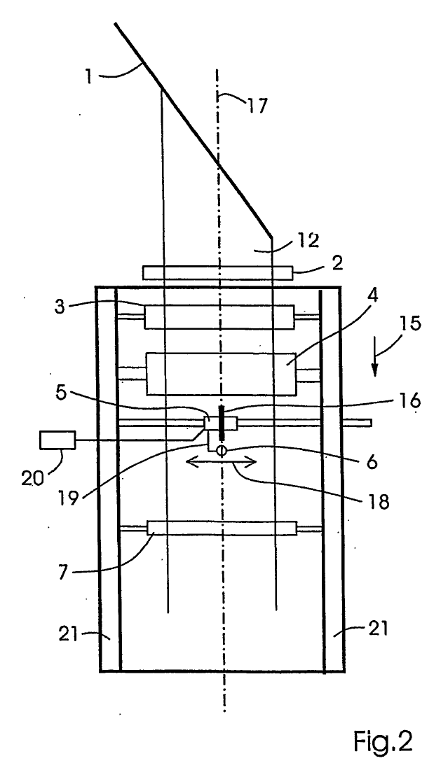

FIG. 2 showing a diagrammatic side view of the embodiment shown in FIG. 1 of a folder according to the invention including a device according to the invention for the longitudinal application of an adhesive.

FIG. 1 diagrammatically illustrates one embodiment of a folder 13 according to the invention in a web-processing printing press 14 including a device according to the invention for the longitudinal application of an adhesive. A web of printing material 12 is folded longitudinally by a former board 1 and folding rollers 2. The web of printing material 12 travels through the folder 13 in a direction of travel 15. Upper nip rollers 3 and lower nip rollers 7 contribute among other drives (not further illustrated here) to the movement of the web of printing material 12. A device for cross-perforation 4, which is preferably embodied as a blade received on a rotating cylinder and cooperating with a counter-pressure element, for instance an anvil received on a further cylinder rotating in synchronism, is arranged downstream of the former board 1, the folding rollers 2, and the upper nip rollers 3 in the direction of travel 15. A device for longitudinal perforation 5, which is assigned an adhesive applicator 6, is arranged downstream of the device for cross-perforation 4. The device for longitudinal perforation 5 and the adhesive applicator 6 are connected by a rigid connection 19. The adhesive applicator 6 has an applicator head 22 that is oriented towards the web of printing material 12 in such a way that an adhesive is applied to the web of printing material 12 downstream of the device for longitudinal perforation 15 as viewed in the direction of travel 15. In the direction of travel 15, the web of printing material 12 reaches a cross-cutter 8 for severing sheets from the web of printing material 12. An accelerated conveyor 9 transports the sheets to a transfer cylinder 10 (folding blade cylinder) and to a jaw cylinder 11.

FIG. 2 is a diagrammatic side view of the embodiment shown in FIG. 1 of a folder 13 according to the invention in a web-processing printing press 14 having a device according to the invention for the longitudinal application of an adhesive. In this view, the web of printing material 12 travelling in the direction of travel 15 is shown as it travels from the former board 1 through the folding rollers 2, the upper nip rollers 3, the device for cross-perforation 4, the device for longitudinal perforation 5, and the lower nip rollers 7. A drive unit 20 is provided for aligning the perforating blade 16 of the device for longitudinal perforation 5 with the axis of a folding line 17. This axis corresponds to a line on the web of printing material 12 for a second longitudinal fold (after a first longitudinal fold has been created by the former board 1) that may be created in the folder for instance by means of a knife folding unit (not further illustrated here). The perforating blade 16 and the adhesive applicator 6 are coupled to each other by a rigid connection 19 so that they are moved in a correlated manner when the device for longitudinal perforation 5 is adjusted in the transversal direction 18. The adhesive applicator 6 is pivotable about the shaft of the device for longitudinal perforation 5 in such a way that the distance between the applicator head 22 and the web of printing material 12 can be changed. The adhesive applicator 6 can be adjusted beyond one of the side frames 21 of the folder 13 such that the adhesive applicator 6 is easily accessible.

### LIST OF REFERENCE NUMERALS

1 former board
2 folding rollers
3 upper nip rollers
4 device for cross-perforation
5 device for longitudinal perforation
6 adhesive applicator
7 lower nip rollers
8 cross cutter
9 accelerated conveyor
10 transfer cylinder
11 jaw cylinder
12 web of printing material
13 folder
14 web-processing printing press
15 direction of travel
16 perforating blade
17 axis of the folding line
18 transversal direction
19 rigid connection
20 drive unit
21 side frame
22 applicator head

1. Device for the longitudinal application of an adhesive in a folder (13), the folder (13) comprising a former board (1), a device for longitudinal perforation (5) having a perforating blade (16) that is adjustable in a direction transversal to the direction of travel (15), and a cross-cutter succeeding each other in the direction of travel (15) of the web of printing material (12), characterized by an adhesive applicator (6) arranged downstream of the former board (1) and upstream of the cross cutter (8) in the direction of travel (15) and including an applicator head (22) that is adjustable with the perforating knife (16) in a correlated manner.

2. Device for the longitudinal application of an adhesive in accordance with claim 1, characterized in that the adhesive applicator (6) is controllable in a pulsed manner.

3. Device for the longitudinal application of an adhesive in accordance with claim 1, characterized in that the applicator head (22) is arranged in such a way that an adhesive is applied to the web of printing material (12) downstream of the device for longitudinal perforation (5) as viewed in the direction of travel (15).

4. Device for the longitudinal application of an adhesive in accordance with claim 1, characterized in that the folder (13) comprises a device for cross-perforation (4) arranged upstream of the device for longitudinal perforation (5) and of the adhesive applicator (6) as viewed in the direction of travel (15).

5. Device for the longitudinal application of an adhesive in accordance with claim 1, characterized by a common drive (20) for the perforating blade (16) and the adhesive applicator (6) jointly adjusting the perforating blade (16) and the adhesive applicator (6) in a direction (18) transversal to the direction of travel (15) in a correlated manner.

6. Device for the longitudinal application of an adhesive in accordance with claim 1, characterized in that the perforating blade (16) and the adhesive applicator (6) are firmly coupled to each other in a direction transversal to the direction of travel (15).

7. Device for the longitudinal application of an adhesive in accordance with claim 1, characterized in that the applicator head (22) is adjustable to different distances to the web of printing material (12).

8. Device for the longitudinal application of an adhesive in accordance with claim 1, characterized in that the adhesive applicator (6) is received in a support adjustable beyond a side frame (21) of the folder (13).

9. Folder (13), characterized by at least one device for the longitudinal application of an adhesive in accordance with claim 1.

10. Web-processing printing press (14), characterized by at least one folder (13) in accordance with claim 9.
